(19) United States
(12) Patent Application Publication
(10) Pub. No.: US 2021/0256243 A1
(43) Pub. Date: Aug. 19, 2021

(54) IMAGE FUSION IN BIOMETRIC SECURITY SYSTEMS

(71) Applicant: QUALCOMM Incorporated, San Diego, CA (US)

(72) Inventors: Ashish HINGER, San Jose, CA (US); Vadim WINEBRAND, San Diego, CA (US)

(21) Appl. No.: 16/792,395

(22) Filed: Feb. 17, 2020

(51) Int. Cl. G06K 9/00; G06T 5/50

(52) U.S. Cl. CPC G06K 9/00067; G06T 2207/20221; G06T 5/50; G06K 9/00087

(57) ABSTRACT

Certain aspects of the present disclosure provide techniques and apparatus for scanning fingerprints in a biometric security system. An example method generally includes receiving a plurality of images of a fingerprint of a user, aligning the plurality of images, and merging the aligned plurality of images into a fused fingerprint image. The fused fingerprint image is output for analysis against a reference fingerprint image associated with the user.

### BACKGROUND

### Field of Disclosure

Aspects of the present disclosure relate to image processing, and more specifically to improving the quality of images captured by an imaging device in an authentication pipeline.

### Description of Related Art

Biometric scanners, such as fingerprint scanners, iris scanners, and the like, generally are used to authenticate users of a device or application prior to allowing the user to access the device or application. To do so, a user generally enrolls with an authentication service (e.g., executing locally on the device or remotely on a separate computing device) by providing one or more scans of a relevant body part to the authentication service that can be used as a reference image. When a user attempts to access the device or application, the user may scan the relevant body part, and the captured image may be compared against the reference image. If the captured image is a sufficient match to the reference image, access to the device or application may be granted to the user. Otherwise, access to the device or application may be denied, as an insufficient match may indicate that a different user is trying to access the device or application.

### SUMMARY

Certain aspects of the present disclosure provide a method for scanning fingerprints in a biometric security system. The method generally includes receiving a plurality of images of a fingerprint of a user, aligning the plurality of images, and merging the aligned plurality of images into a fused fingerprint image. The fused fingerprint image is output for analysis against a reference fingerprint image associated with the user.

Further aspects of the present disclosure provide an apparatus having a memory configured to store instructions and a processor coupled to the memory and configured to execute the instructions. The instructions generally includes code for: receiving a plurality of images of a fingerprint of a user, aligning the plurality of images, merging the aligned plurality of images into a fused fingerprint image, and outputting the fused fingerprint image for analysis against a reference fingerprint image associated with the user.

Still further aspects of the present disclosure provide a non-transitory computer-readable medium having instructions stored thereon which, when executed by a processor, cause the processor to perform an operation for scanning fingerprints (e.g., in a biometric security system). The operation generally includes receiving a plurality of images of a fingerprint of a user, aligning the plurality of images, merging the aligned plurality of images into a fused fingerprint image, and outputting the fused fingerprint image for analysis against a reference fingerprint image associated with the user.

The following description and the related drawings set forth in detail certain illustrative features of one or more aspects.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates a conventional pipeline for capturing and analyzing images of a biometric characteristic.

FIG. 2 illustrates example operations for generating a fused image of a user fingerprint for use in a biometric security system, according to aspects described herein.

FIG. 3 illustrates a flow chart for capturing and processing images of a fingerprint in a biometric security system, according to aspects described herein.

FIG. 4 illustrates a pipeline for fusing images of a user fingerprint and using the fused image in a biometric security system, according to aspects described herein.

FIG. 5 illustrates an example schematic diagram of a multi-processor processing system that may be implemented with aspects described herein.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatus, methods, and computer-readable mediums for fusing images of a captured biometric characteristic into an improved quality image for use in allowing or disallowing access to resources in a biometric security system.

In many biometric security systems, images are generally captured of a biometric characteristic of a user (e.g., a fingerprint, face structure derived from a facial scan, iris structure derived from an iris scan, etc.) for use in authenticating a user. The degree of similarity needed between a captured image and a reference image may be tailored to meet false acceptance rate (FAR) and false rejection rate (FRR) metrics. The FAR may represent a rate at which a biometric security system incorrectly allows access to a system or application (e.g., to a user other than the user(s) associated with reference image(s) in the biometric security system), and the FRR may represent a rate at which a biometric security system incorrectly blocks access to a system or application. Generally, a false acceptance may constitute a security breach, while a false rejection may be an annoyance. Because biometric security systems are frequently used to allow or disallow access to potentially sensitive information or systems, and because false acceptances are generally dangerous, biometric security systems may typically be configured to minimize the FAR to as close to zero as possible, usually with the tradeoff of an increased FRR.

In some cases, false rejections may be caused when a biometric scanner captures an image of a biometric characteristic with low quality. The quality of an image captured of a biometric characteristic may vary based on a number of factors. A low quality image may be generated, for example, due to movement during image capture, foreign substances interposed between the biometric scanner and the biometric characteristic, physical characteristics that may impact the quality of a captured image, and the like. For example, on a mobile device, the quality of a fingerprint scan may be negatively affected if a user places a protective film over a fingerprint sensor, moves while the finger is being scanned, or has dry hands that impact the ability of the scanner to generate a scan that distinguishes ridges and valleys of a fingerprint. Likewise, the quality of an iris scan may be negatively affected if a user places a protective film over an iris scanner, moves during the scan (e.g., such that the distance of the user's eye from the focal plane of the iris scanner changes), and the like.

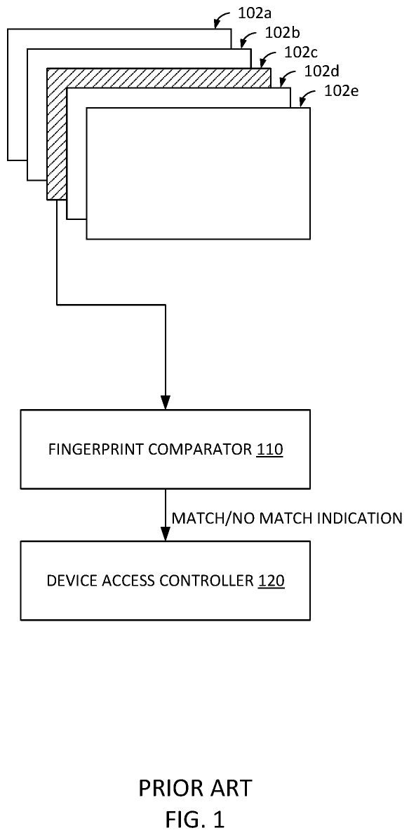

FIG. 1 illustrates a conventional pipeline 100 for authenticating a user of a device or application accessed by the device based on images captured of a biometric characteristic of a user. As illustrated, pipeline 100 may start with a biometric scanner capturing a plurality of images 102a-102e (collectively “images 102”). Each image of the plurality of images 102 may be processed to determine a quality metric for each image. The quality metric may indicate, for example, a degree of usable information in an image. An image that lacks detail, is out of focus (e.g., due to user movement), or otherwise includes little in the way of usable information may have a low score on a quality metric (e.g., have a low signal-to-noise ratio), while images that are sharp or otherwise include significant amounts of usable information have a high score on the quality metric (e.g., have a high signal-to-noise ratio).

As illustrated, image 102c may be deemed the image with the highest quality. Images 102a, 102b, 102d, and 102e may be discarded, and image 102c may be provided to fingerprint comparator 110 for comparison to a reference image. Fingerprint comparator 110 can generate an indication of whether image 102c matched the reference image of the user's fingerprint and output the match/no match indication to a device access controller 120. Based on the match/no match indication, device access controller 120 can allow or disallow access to the device or the application. If fingerprint comparator 110 generates a match indication, device access controller 120 can allow access to the device (e.g., unlock the device such that the user can interact with applications on the device) or authenticate a user with the application executing on the device. Otherwise, device access controller 120 can block access to the device or application executing on the device. If device access controller 120 blocks access to the device or application executing on the device, the user may be prompted to try authenticating again using a biometric scanner until a limit to the number of attempts is reached, at which point the user may be prompted to enter a password or PIN code to interact with the device or application executing on the device.

As discussed, biometric authentication using a single image may fail to authenticate a user for various reasons. However, while each image captured of a biometric characteristic may not include sufficient information to authenticate a user by itself, a combination of the images may include sufficient information to authenticate the user. Accordingly, aspects of the present disclosure provide techniques and apparatus for improving the quality of captured images used in biometric authentication systems, for example, by fusing a plurality of images together into a single, higher quality image that may include sufficient information to authenticate the user.

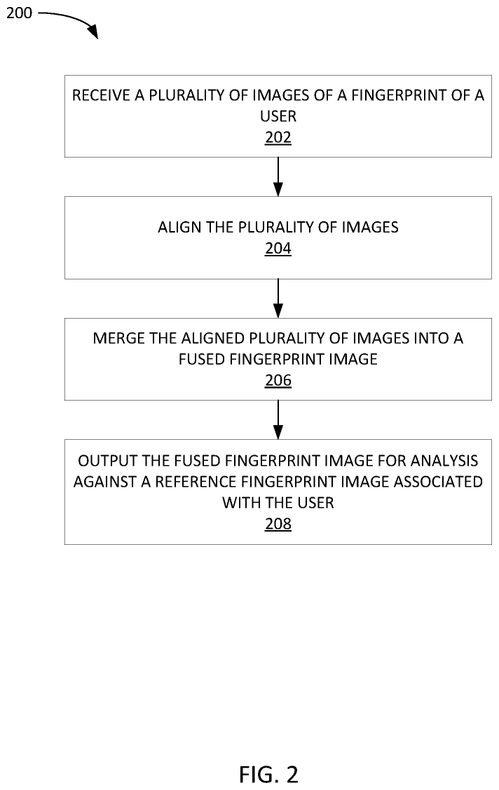

FIG. 2 illustrates example operations 200 that may be performed to fuse a plurality of captured images of a user biometric characteristic into a fused image that may be used to authenticate a user, according to aspects described herein. The operations 200 may be performed, for example, by an apparatus (e.g., a laptop, tablet, or mobile device) with a biometric security system capable of scanning a fingerprint.

As illustrated, operations 200 may begin at block 202, where the apparatus receives a plurality of images of a fingerprint of a user. The plurality of images may be, for example, a stream of sequential images captured by a biometric characteristic scanner.

At block 204, the apparatus aligns the plurality of images. Generally, in aligning the plurality of images, the apparatus may rotate and/or translate each of the plurality of images so that the images can be stacked and combined into a fused image, thus increasing the amount of information included in the fused image relative to any single image of the plurality of images. To align the image, the apparatus may identify an orientation of one or more features in one image to be used as references for the other images in the plurality of images. Each of the other images in the plurality of images may be rotated such that the orientation of the one or more features in the first image matches the orientation of those features in the other images. A translation may be applied to each of the other images to move the position of the one or more features such that the one or more features are in the same or substantially same position (e.g., pixel coordinates) relative to an origin point.

At block 206, the apparatus merges the aligned plurality of images into a fused fingerprint image.

At block 208, the apparatus outputs the fused fingerprint image for analysis against a reference fingerprint image associated with the user.

In some aspects, the apparatus can align the plurality of images by performing alignment operations with respect to at least one image in the plurality of images. To do so, the apparatus may rotate the at least one image to align the at least one image with another image in the plurality of images or translate the at least one image to align the at least one image with the other image.

In some aspects, each image in the plurality of images may be associated with a respective quality metric. The plurality of images may be merged based on the respective quality metric for each of the plurality of images. To merge the images, each image in the plurality of images may be modified using the quality metric of each respective image as a weighting factor. The modified images may be additively combined to generate the fused fingerprint image.

In some aspects, the quality metric may indicate an image quality of the respective image relative to an image in the plurality of images with a highest quality and an image in the plurality of images having a lowest quality. For example, on a 0-1 scoring scale, the image with the highest quality may be assigned a score of 1, the image with the lowest quality may be assigned a score of 0, and the other images in the plurality of images may be assigned scores commensurate with their quality relative to the highest and lowest quality images.

In some aspects, the apparatus may merge the aligned plurality of images into a fused fingerprint image by modifying each image in the plurality of images based on an equal weighting over the number of the plurality of images. The modified images may be additively combined to generate the fused fingerprint image.

In some aspects, the apparatus may merge the aligned plurality of images into the fused fingerprint images by modifying each respective image in the plurality of images based on an amount of gain applied to the respective image relative to a total amount of gain applied to the plurality of images. The total amount of gain applied to the plurality of images may be a summation of individual gains (e.g., an amount of amplification) applied by an imaging device to an input to generate each of the plurality of images. The apparatus may additively combine the modified images together to generate the fused fingerprint image.

In some aspects, aligning the plurality of images may include generating, for at least one image in the plurality of images, a rotated image including white space and content from the at least one image rotated according to a determined rotation to align the at least one image with another image in the plurality of images. One or more images of the plurality of images may be translated such that a location of a predetermined feature in each respective image in the plurality of images is substantially identical.

In some aspects, the apparatus may identify a first image as an inversion of a second image in the plurality of images. The first image may be inverted (e.g., in a black-and-white source image, changing black pixels in the source image to white pixels and white pixels in the source image to black pixels). By inverting the first image, what appears initially as fingerprint valleys may be changed to fingerprint ridges, and what appears initially as fingerprint ridges may be changed to fingerprint valleys. In some cases, identifying a first image as an inversion of a second image may comprise performing a cross-correlation between the first image and the second image to identify one image as an inversion of the other.

In some aspects, receiving the plurality of images of the fingerprint of the user may include receiving a first plurality of images. A quality metric may be determined for the first plurality of images. Upon determining that the quality metric for the first plurality of images is less than a threshold value, a second plurality of images may be obtained from a fingerprint scanner.

In some aspects, the apparatus may compare the fused fingerprint image against the reference fingerprint image associated with the user. Access to the apparatus may be allowed based on determining that the fused fingerprint image substantially matches the reference fingerprint image. Access to the apparatus, however, may be disallowed based on determining that the fused fingerprint image does not substantially match the reference fingerprint image.

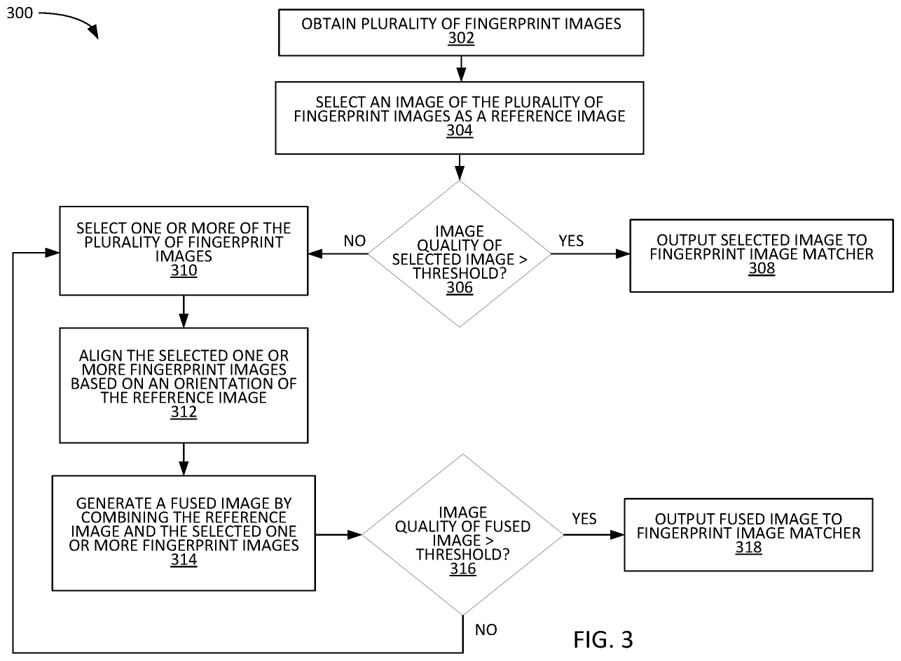

FIG. 3 illustrates an example flow chart of operations 300 for capturing and processing images of a fingerprint in a biometric security system, according to aspects described herein.

As illustrated, operations 300 begin at block 302, where a system obtains a plurality of fingerprint images from an imaging device.

At block 304, the system selects an image of the plurality of fingerprint images as a reference image. The reference image may be, for example, the image of the plurality of fingerprint images having a highest image quality of the plurality of fingerprint images. As discussed, image quality may be calculated, for example, as a signal-to-noise ratio, an amount of gain applied to a raw analog input to generate an image (e.g., where lower amounts of gain imply higher image quality), or the like.

At block 306, the system determines whether the image quality of the selected image exceeds a threshold image quality. If the image quality of the selected image exceeds the threshold image quality, the system can infer that the quality of the selected image is sufficient for use by a fingerprint image matcher in authenticating a user. Thus, operations 300 may proceed to block 308, where the system outputs the selected image to a fingerprint image matcher for use in authenticating a user and allowing or disallowing access to a system, application, or other resources based on whether the selected image matches the enrolled fingerprint of a user of the system.

If, at block 306, the system determines that the image quality of the selected image is less than the threshold image quality, operations 300 may proceed to block 310. At block 310, the system selects one or more of the plurality of fingerprint images. In some aspects, the system can select the n fingerprint images obtained at block 302 having the highest image quality metrics of the plurality of images.

At block 312, the system aligns the selected one or more fingerprint images based on an orientation of the reference image. As discussed, in aligning the selected one or more fingerprint images, the system can select one or more features in the reference image as reference features for aligning the one or more images. The selected one or more fingerprint images may be rotated such that the positions of the reference features in each of the selected one or more fingerprint images is the same or substantially the same as the positions of the reference features in the reference image. Additionally or alternatively, a positional translation may be applied to the one or more images such that the reference features are located at the same locations in each of the one or more images and the reference image (e.g., at the same pixel coordinates) to avoid ghosting or other image misalignment problems.

At block 314, the system generates a fused image by combining the reference image and the selected one or more fingerprint images. The system can generate the fused image in various manners. For example, the fused images may be additively combined using the selected and aligned images without further processing. In some aspects, various weighting modifications may be made to each image prior to additively combining the images together. For example, images may be modified according to a weighting factor associated with an image quality metric calculated for each of the plurality of images. For example, a weighting factor applied to the selected images may result in images with a higher quality having a larger impact on the fused image than images with a lower quality. In some aspects, an equal weighting may be applied to each of the one or more images (e.g., effectively taking the average of the images).

At block 316, the system determines whether the image quality of the fused image exceeds a threshold image quality. If the image quality of the fused image does not exceed the image quality threshold, the system may determine that additional images are to be combined with the fused image in order to generate a usable image. Thus, operations 300 may return to block 310 to select one or more images to combine with the fused image, or to combine together to generate another fused image. For other aspects, the operations 300 may return to block 302 to obtain additional fingerprint images. If, however, the image quality of the fused image exceeds the image quality threshold, operations 300 may proceed to block 318, where the system outputs the fused image to the fingerprint image matcher.

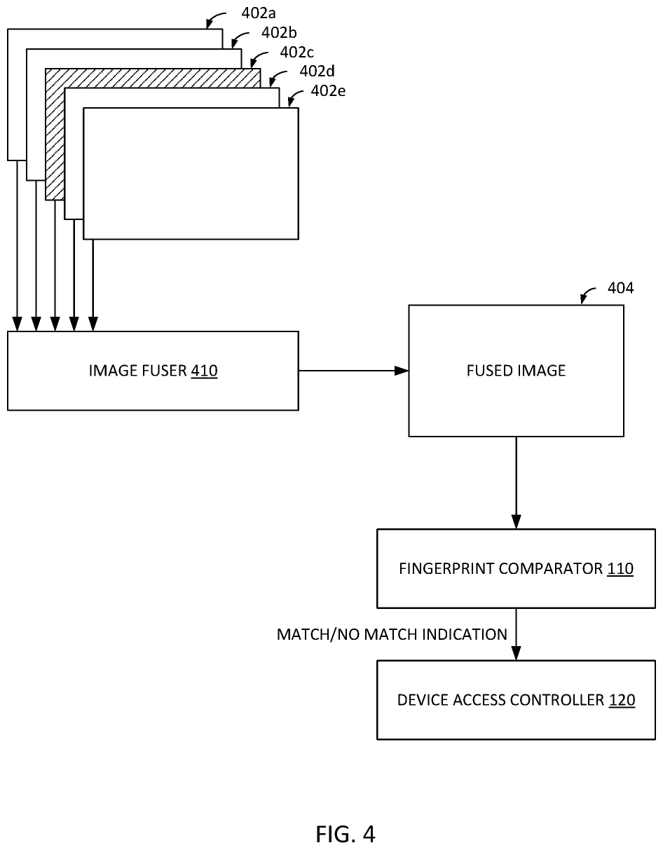

FIG. 4 illustrates a pipeline for authenticating a user of a device or application based on images captured of a biometric characteristic of the user fused into a single fused image. As illustrated, the pipeline may start with a biometric scanner capturing a plurality of images 402a-402e (collectively, “images 402”). Although five images 402 are shown in FIG. 4, the reader is to understand that more or less than five images may be captured.

While image 402c may be the image with the highest quality of the plurality of images 402, image 402c may not be the only image output to a fingerprint comparator for comparison to a reference image. Rather, images 402a-402e may be output to image fuser 410, where the images are analyzed, processed (e.g., aligned), and combined into fused image 404. As discussed, image fuser 410 can select one of the images 402 as an alignment reference image (e.g., image 402c, which may be the image with the highest quality of the plurality of images). The other images (e.g., images 402a, 402b, 402d, and 402e) may be aligned based on one or more features in the alignment reference image 402c. As discussed, the images other than the alignment reference image 402c may be rotated and/or translated such that the position of the one or more features is the same or substantially the same in each image 402 (e.g., at the same pixel coordinates).

After aligning the images 402, image fuser 410 may combine the images 402 into a fused image 404. To do so, image fuser 410 may additively combine the images 402. In some aspects, a weighting may be applied to each of the images 402 prior to image fuser 410 combining images 402 into fused image 404. The weighting may be an equal weighting, a weighting based on an image quality metric calculated for each of the images 402, a weighting based on an amount of gain applied to an input signal to generate each of images 402, or another suitable weighting.

Fused image 404 may be output to a fingerprint comparator 110 which, as discussed above, compares a received image to a reference image of a user's fingerprint that has been previously enrolled. Fingerprint comparator 110 generates a match/no match indication, which may be output to device access controller 120 for use in determining whether to allow or disallow access to the device or application executing on the device.

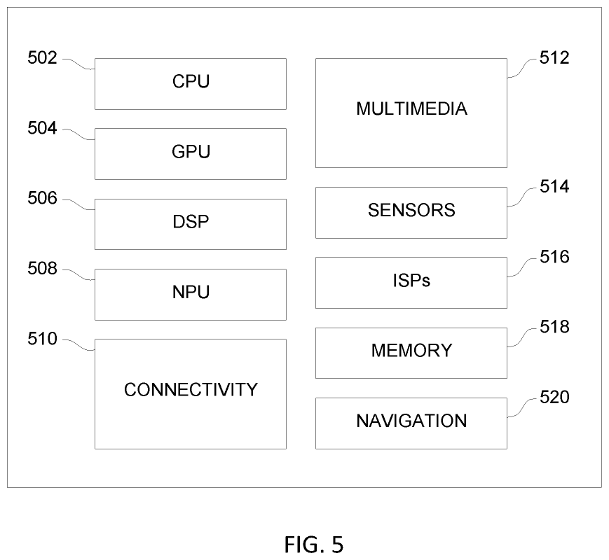

FIG. 5 illustrates an example implementation of a system-on-a-chip (SoC) 500, which may include a central processing unit (CPU) 502 or a multi-core CPU configured to fuse images captured of a user biometric characteristic into a single image used by a biometric security system to allow or disallow access to a system, application, or protected resources stored or accessed thereon, according to aspects described herein. Image information captured by a biometric scanner may be stored in a memory block associated with a neural processing unit (NPU) 508, in a memory block associated with a CPU 502, in a memory block associated with a graphics processing unit (GPU) 504, in a memory block associated with a digital signal processor (DSP) 506, in a memory block 518, or may be distributed across multiple blocks. Instructions executed at the CPU 1002 may be loaded from a program memory associated with the CPU 1002 or may be loaded from a memory block 1018.

The SoC 500 may also include additional processing blocks tailored to specific functions, such as a GPU 504, a DSP 506, a connectivity block 510, which may include Fifth Generation (5G) connectivity, Fourth Generation Long Term Evolution (4G LTE) connectivity, Wi-Fi connectivity, Universal Serial Bus (USB) connectivity, Bluetooth connectivity, and the like, and a multimedia processor 512 that may, for example, detect and recognize gestures. In one implementation, the NPU is implemented in the CPU 502, DSP 506, and/or GPU 504. The SoC 500 may also include a sensor processor 514, image signal processors (ISPs) 516, and/or navigation module 520, which may include a Global Positioning System (GPS).

The SoC 500 may be based on an advanced reduced instruction set computing (RISC) machine (ARM) instruction set. In an aspect of the present disclosure, the instructions loaded into the CPU 502 may comprise code to combine images of a user biometric characteristic into a single fused image used by a biometric security system to determine whether to allow or disallow access to a system or protected resources stored thereon.

SoC 500 and/or components thereof may be configured to perform the methods described herein.

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for scanning fingerprints, comprising:
receiving a plurality of images of a fingerprint of a user;
aligning the plurality of images;
merging the aligned plurality of images into a fused fingerprint image; and
outputting the fused fingerprint image for analysis against a reference fingerprint image associated with the user.

2. The method of claim 1, wherein aligning the plurality of images comprises, for at least one image in the plurality of images, at least one of:
rotating the at least one image to align the at least one image with another image in the plurality of images; or
translating the at least one image to align the at least one image with the other image.

3. The method of claim 1, wherein each respective image in the plurality of images is associated with a respective quality metric.

4. The method of claim 3, wherein merging the aligned plurality of images into the fused fingerprint image comprises:
modifying each respective image in the plurality of images using the respective quality metric as a weighting factor; and
additively combining the modified images together to generate the fused fingerprint image.

5. The method of claim 3, wherein the respective quality metric indicates an image quality of the respective image relative to an image in the plurality of images with a highest quality and an image in the plurality of images having a lowest quality.

6. The method of claim 1, wherein merging the aligned plurality of images into the fused fingerprint image comprises:
modifying each respective image in the plurality of images based on an equal weighting over a number of the plurality of images; and
additively combining the modified images together to generate the fused fingerprint image.

7. The method of claim 1, wherein merging the aligned plurality of images into the fused fingerprint image comprises:
modifying each respective image in the plurality of images based on an amount of gain applied to the respective image relative to a total amount of gain applied to the plurality of images; and
additively combining the modified images together to generate the fused fingerprint image.

8. The method of claim 1, wherein aligning the plurality of images comprises:
for at least one image in the plurality of images, generating a rotated image including white space and content from the at least one image rotated according to a determined rotation to align the at least one image with another image in the plurality of images; and
translating one or more images of the plurality of images such that a location of a predetermined feature in each respective image in the plurality of images is substantially identical.

9. The method of claim 1, further comprising:
identifying a first image as an inversion of a second image in the plurality of images; and
inverting the first image so as to change fingerprint valleys to fingerprint ridges and fingerprint ridges to fingerprint valleys in the first image.

10. The method of claim 9, wherein the identifying comprises performing a cross-correlation between the first image and the second image.

11. The method of claim 1, wherein receiving the plurality of images of the fingerprint of the user comprises:
receiving a first plurality of images;
determining a quality metric for the first plurality of images; and
upon determining that the quality metric for the first plurality of images is less than a threshold value, obtaining a second plurality of images from a fingerprint scanner.

12. The method of claim 1, further comprising:
comparing the fused fingerprint image against the reference fingerprint image associated with the user; and
allowing access to a device based on determining that the fused fingerprint image substantially matches the reference fingerprint image; or
disallowing access to the device based on determining that the fused fingerprint image does not substantially match the reference fingerprint image.

13. An apparatus comprising:
a memory configured to store instructions; and
a processor coupled to the memory and configured to execute the instructions, the instructions comprising code for:
receiving a plurality of images of a fingerprint of a user;
aligning the plurality of images;
merging the aligned plurality of images into a fused fingerprint image; and
outputting the fused fingerprint image for analysis against a reference fingerprint image associated with the user.

14. The apparatus of claim 13, wherein aligning the plurality of images comprises, for at least one image in the plurality of images, at least one of:
rotating the at least one image to align the at least one image with another image in the plurality of images; or
translating the at least one image to align the at least one image with the other image.

15. The apparatus of claim 13, wherein:
each respective image in the plurality of images is associated with a respective quality metric; and
merging the aligned plurality of images into the fused fingerprint image comprises:
modifying each respective image in the plurality of images using the respective quality metric as a weighting factor; and
additively combining the modified images together to generate the fused fingerprint image.

16. The apparatus of claim 13, wherein merging the aligned plurality of images into the fused fingerprint image comprises:
modifying each respective image in the plurality of images based on an amount of gain applied to the respective image relative to a total amount of gain applied to the plurality of images; and
additively combining the modified images together to generate the fused fingerprint image.

17. The apparatus of claim 13, wherein aligning the plurality of images comprises:
for at least one image in the plurality of images, generating a rotated image including white space and content from the at least one image rotated according to a determined rotation to align the at least one image with another image in the plurality of images; and
translating one or more images of the plurality of images such that a location of a predetermined feature in each respective image in the plurality of images is substantially identical.

18. The apparatus of claim 13, wherein receiving the plurality of images of the fingerprint of the user comprises:
receiving a first plurality of images;
determining a quality metric for the first plurality of images; and
upon determining that the quality metric for the first plurality of images is less than a threshold value, obtaining a second plurality of images from a fingerprint scanner.

19. The apparatus of claim 13, wherein the instructions further comprise code for:
comparing the fused fingerprint image against the reference fingerprint image associated with the user; and
allowing access to the apparatus based on determining that the fused fingerprint image substantially matches the reference fingerprint image; or
disallowing access to the apparatus based on determining that the fused fingerprint image does not substantially match the reference fingerprint image.

20. A non-transitory computer-readable medium having instructions stored thereon which, when executed by a processor, cause the processor to perform an operation for scanning fingerprints, the operation comprising:
receiving a plurality of images of a fingerprint of a user;
aligning the plurality of images;
merging the aligned plurality of images into a fused fingerprint image; and
outputting the fused fingerprint image for analysis against a reference fingerprint image associated with the user.
